(19) United States
(12) Patent Application Publication
(10) Pub. No.: US 2010/0132323 A1
(43) Pub. Date: Jun. 3, 2010

(54) FILETER ELEMENT PRODUCED BY EXTRUSION FOR FILTERING EXHAUST GASES OF A DIESEL INTERNAL COMBUSTION ENGINE

(76) Inventors: Klaus-Dieter Sulzberger, Schwieberdingen (DE); Teruo Komori, Ogaki City Gifu (JP); Thomas Hauber, Altbach (DE)

Correspondence Address: KENYON & KENYON LLP, ONE BROADWAY, NEW YORK, NY, 10004, US

(21) Appl. No.: 12/312,804

(22) PCT Filed: Oct. 16, 2007
(86) PCT No.: PCT/EP2007/061027

§ 371 Date: Jan. 15, 2010

(30) Foreign Application Priority Data
Dec. 5, 2006 (DE) 10 2006 057 280.7

(51) Int. Cl. F01N 3/022; B01D 39/20; B01D 46/24

(52) U.S. Cl. 55/523; 55/529

(57) ABSTRACT

A filter element for a soot particle filter includes a blank which is designed, during extrusion, specifically not to be round, so that, in response to subsequent heat treatment, the different shrinkage measurements in the radial direction become equalized, and a filter element that has a circular cross section is produced.

### BACKGROUND OF THE INVENTION

1. Field of the Invention

The present invention relates to a filter element, particularly for an exhaust gas system of an internal combustion engine.

2. Description of Related Art

Such filter elements, produced by extrusion, having an inlet surface and an outlet surface, and having a plurality of inlet channels and a plurality of outlet channels are sufficiently well known. The inlet channels and the outlet channels are separated by a filter wall made of an open-pored material. While flowing through the filter element, the exhaust gas that is to be purified goes from the inlet channels to the outlet channels by flowing through the filter walls. In order for the exhaust gas that is to be purified to have to flow through the filter walls, the gap between the filter element and the housing has to be, first of all, as small as possible, and secondly, it has to be sealed to be gastight by suitable materials.

The housing is usually designed to be tube-shaped. However, since usual filter elements are not round after firing, the gap between the circular housing and the filter element has to be selected to be relatively large. If the gap between the filter element and the housing is of unequal size, it can only be sealed in a very costly manner. That is why, on occasion, people have taken to grinding the filter element to be cylindrical after firing. Both alternatives are very costly, and this runs counter to application in mass production, for this reason alone.

### BRIEF SUMMARY OF THE INVENTION

An object of the present invention is to provide a filter element that is able to be fastened in sealing fashion in the housing, in a simpler, more reliable and more cost-effective manner.

This object is attained, according to the present invention, by a filter element, especially for filtering the exhaust gases of a diesel internal combustion engine, having an inlet surface and an outlet surface, and having a plurality of inlet channels and a plurality of outlet channels, the inlet channels and the outlet channels being separated by a filter wall made of an open-pored material; the filter element being produced by extrusion and subsequent heat treatment, in that the extruded blank of the filter element has a greater diameter at the circumferential angles at which the filter walls run essentially radially, than at the circumferential angles at which a radius runs essentially along the bisector between the filter elements.

During investigations of usual filter elements, it turned out that a finished, fired filter element has a smaller diameter at the circumferential angles at which the filter walls run radially than at the circumferential angles at which a radius runs essentially along the bisector between the filter walls.

It is now provided, according to the present invention, to counteract this undesired effect that originates from the different shrinkage behavior of the blank during firing, by using an appropriate design of the blank during extrusion. By doing that, the cylindricity of a filter element according to the present invention, after firing is able to be clearly improved over usual filter elements, so that, first of all, the grinding of the filter element can be omitted and, secondly, the gap between filter element and housing is able to be clearly reduced. As a result, the tightness between the filter element and the housing is simplified and improved.

The filter elements according to the present invention has the additional advantage that its production is not connected with increased costs, since, after all, only slight additional costs are created in the production of the extrusion tool required for extruding the blanks.

An extrusion tool designed in this way is able to be integrated without a problem into an already existing production device, so that even the conversion of filter elements, that are already being made in mass production, to the geometry of the blanks according to the present invention, is able to take place without a problem and during the course of a regular tool change.

In the case of a filter element whose filter walls include an angle of about 90° and the filter element has an essentially circular cross section, it is provided that the extruded blank of the filter element have a greater diameter at the circumferential angles at which the filter walls run essentially radially, than at the circumferential angles at which a radius runs essentially along the bisector between the filter walls.

This makes it possible to produce a filter element whose cross section, after firing, is circular to a sufficient degree of accuracy, so that the filter element is able to be pushed into a circular housing, without a problem, and sealed there.

It is also advantageous if the areas of the filter element having a greater diameter and the areas having a smaller diameter merge into one another steplessly, since jumps or steps in diameter of the filter element would, in turn, lead to an unfavorable development of the gap between filter element and housing.

The difference between the greater diameter and the smaller diameter of the blank of a filter element after extruding is advantageously selected as a function of the positioning of the filter walls and of the diameter of the filter element, in such a way that, after the firing, the cross section of the filter element has the desired shape. In the case of a cylindrical filter element, this is naturally a circular cross section. However, the filter element according to the present invention may also be successfully used, for instance, for filter elements having a quadratic cross section and housing having a quadratic cross section.

### BRIEF DESCRIPTION OF SEVERAL VIEWS OF THE DRAWING

FIG. 1 shows a schematic illustration of an internal combustion engine having an exhaust-gas aftertreatment device according to the present invention.

FIG. 2 shows a filter element according to the present invention, in longitudinal section.

FIG. 3 shows a cross section through a blank of a filter element after extrusion.

FIG. 4 shows a cross section through the filter element according to FIG. 3, after heat treatment.

### DETAILED DESCRIPTION OF THE INVENTION

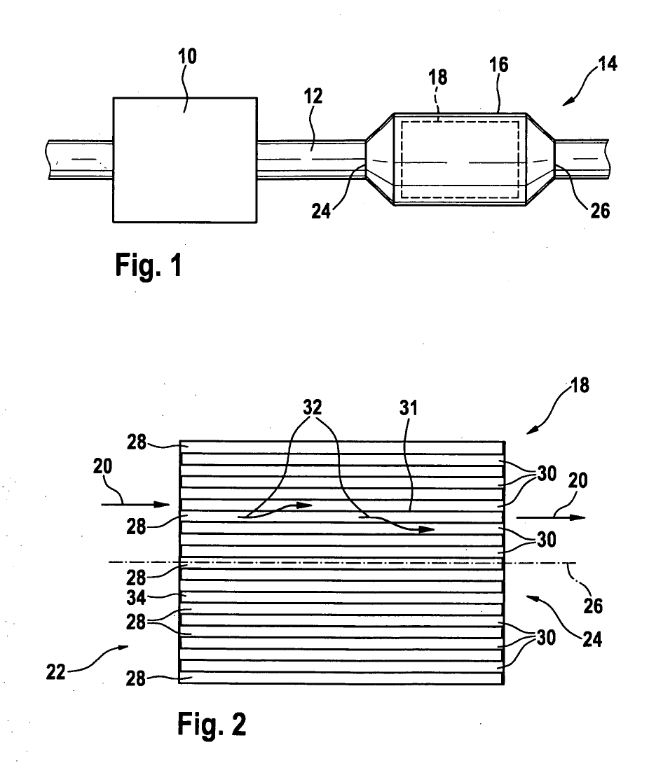

In FIG. 1, an internal combustion engine is denoted by reference numeral 10. The exhaust gases are carried away via an exhaust pipe 12 inside which a filtering device 14 is disposed. It is used to filter carbon particulate out of the exhaust gas flowing inside exhaust pipe 12. This is required in particular in the case of Diesel gasoline engines, in order to comply with legal provisions.

Filtering device 14 includes a cylindrical housing 16 in which a filter structure 18 is disposed, which in the present exemplary embodiment is rotationally symmetrical, and altogether also cylindrical.

FIG. 2 shows a cross section through a filter element 18 according to the present invention. Filter element 18 is able to be produced as an extruded molded body made of a ceramic material such as cordierite, for example.

Exhaust gas, which is not shown, flows through filter element 18 in the direction of arrows 20. An inlet area bears reference numeral 22 in FIG. 2, while an outlet area bears reference numeral 24 in FIG. 2.

A plurality of inlet channels 28 runs parallel to a longitudinal axis 26 of filter element 18, alternating with outlet channels 30. Inlet channels 28 are closed at outlet surface 24. The closing plugs are shown without reference numerals in FIG. 2. In contrast, outlet channels 30 are open at outlet surface 24 and closed in the area of inlet surface 22.

The flow path of the unpurified exhaust gas thus leads into one of inlet channels 28 and from there, through a filter wall 31, into one of outlet channels 30. This is shown by way of example by arrows 32.

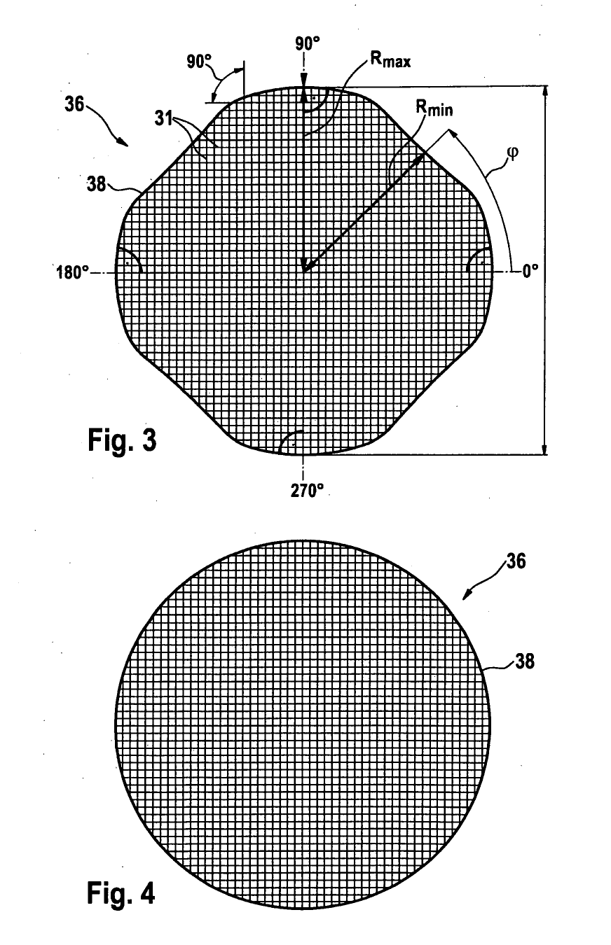

FIG. 3 shows a blank 36 of a filter element in cross section, after extrusion and before a subsequent heat treatment. For reasons of clarity, filter walls 31, and with them, inlet channels 28 and outlet channels 30, are not shown over the entire cross section of blank 36. Of importance for the present invention is that filter walls 31 have two main directions, which include an angle of 90°. The first main direction corresponds to an angle of 0° in the polar coordinate system entered in FIG. 3. The origin of this coordinate system is at the center of the cross section of blank 36.

It becomes clear from FIG. 3 that, at circumferential angles φ of 0°, 90°, 180° and 270°, filter walls 31 run essentially radially. At the circumferential angles named, an outer surface 38 of blank 36 runs at a right angle to radial filter walls 31. At a circumferential angle φ of 45°, a radius R lies in the bisector between the main directions of filter walls 31. Of necessity, at a circumferential angle of 45°, this leads to filter walls 31 running at an angle of about 45° to outer surface 38 of the blank.

During production of such blanks and subsequent firing, it has been shown that the shrinkage in the radial direction is not the same during the firing of the blank. The shrinkage in the radial direction depends on the angle between filter walls 31 and outer surface 38 of filter element 18. As a result, a finished, fired filter element, whose blank has an exactly circular cross section, is no longer circular after the firing.

In order to prevent this undesired effect, it is provided, according to the present invention, to develop an extruded blank in such a way that its cross section, after extrusion and before firing, deviates in a specific manner from the desired cross section of the finished, fired filter element.

This enables one to compensate for the different shrinkage measurements created during firing.

In the exemplary embodiment according to FIG. 3, it is provided by the present invention that, in the case of circumferential angles of 0°, 90°, 180° and 270°, radius R takes on a maximum value Rₘₐₓ, while at values of circumferential angles φ of 45°, 135°, 225° and 315° it takes on a minimum Rₘᵢₙ. The transition between maximum radius Rₘₐₓ and minimum radius Rₘᵢₙ takes place steplessly, so that blank 36 has the “clover leaf-shaped” cross section shown in FIG. 3.

Now, if blank 36 according to FIG. 3 is submitted to heat treatment in a manner known per se, the blank shrinks unevenly during firing, as a function of circumferential angle cp. The clover leaf shape vanishes thereby, and a filter element 18 is created which has the circular cross sectional surface shown in FIG. 4.

It should be understood that the present invention is not limited to filter elements having circular final cross sections and filter walls 31 which include an angle of 90°, but are able to be successfully used at almost all cross sectional geometries and shapes of the filter walls.

1-6. (canceled)

7. A filter element for filtering exhaust gases of a Diesel engine, comprising:
an inlet surface at a first end of the filter element;
an outlet surface at a second end of the filter element;
a plurality of inlet channels extending along the longitudinal axis of the filter element between the inlet surface and the outlet surface;
a plurality of outlet channels extending along the longitudinal axis of the filter element between the inlet surface and the outlet surface; and
a plurality of filter walls extending along the longitudinal axis of the filter element and separating the inlet channels from the outlet channels, wherein the filter walls are made of an open-pored material;
wherein the filter element, in an extruded state, has a first radius value at circumferential angles of the radius of the filter element at which the radius extends at least one of orthogonal to and parallel to the filter walls, and a second radius value at circumferential angles of the radius at which the radius extends substantially along a diagonal bisector between the filter walls, wherein the first radius value is greater than the second radius value, and wherein the difference between the first radius and the second radius is selected so that the filter element has a different, desired cross section in a state after the filter element has been heat-treated.

8. The filter element as recited in claim 7, wherein:
the filter element has an essentially circular cross section;
the first radius value occurs at circumferential angles which are multiples of approximately 90 degrees; and
the second radius value occurs at circumferential angles which are multiples of 45 degrees.

9. The filter element as recited in claim 8 wherein a transition between a circumferential angle corresponding to the first radius value and a circumferential angle corresponding to the second radius value occurs steplessly.

10. The filter element as recited in claim 8, wherein the inlet channels are open at the inlet surface and closed at the outlet surface, and wherein the outlet channels are closed at the inlet surface and open at the outlet surface.

11. The filter element as recited in claim 8, wherein the filter element is made of ceramic material.
